(19) United States
(12) Patent Application Publication
(10) Pub. No.: US 2003/0067641 A1
(43) Pub. Date: Apr. 10, 2003

(54) Apparatus and methods for polarization measurements across a spectral range

(75) Inventors: Steven J. Wein, Sudbury, MA (US); James D. Targove, Sudbury, MA (US); Arthur Menikoff, Harvard, MA (US)

Correspondence Address: TESTA, HURWITZ & THIBEAULT, LLP, HIGH STREET TOWER, 125 HIGH STREET, BOSTON, MA, 02110, US

(73) Assignee: Terapulse, Inc., Acton, MA

(21) Appl. No.: 10/218,681

(22) Filed: Aug. 14, 2002

Related U.S. Application Data
(60) Provisional application No. 60/312,288, filed on Aug. 14, 2001.

(51) Int. Cl. H04B 10/08

(52) U.S. Cl. 359/110

(57) ABSTRACT

Apparatus and methods for polarimetric measurements across a spectral range, such as determining the polarimetric state across a wavelength band in a wavelength-division multiplexed fiber optic channel. A variable phase delay is introduced between orthogonal polarization components in an incident light. The resulting intensity changes are used to compute parameters indicative of the polarimetric state of the light. These measurements may be used, for example, for polarimetric imaging, polarimetric component characterization, and measuring polarization states in a fiber link.

### CROSS-REFERENCE TO RELATED APPLICATIONS

The present application claims the benefit of co-pending provisional application Serial No. 60/312,288, filed on Aug. 14, 2001, the entire disclosure of which is incorporated by reference as if set forth in its entirety herein.

### FIELD OF THE INVENTION

The invention relates to the field of optical measurement systems and, in particular, to apparatus and methods for measurements of polarimetric state.

### BACKGROUND OF THE INVENTION

A polarimeter may be used to measure the electric field orientation, i.e., the polarization, of light. Elliptical polarization, depicted in FIG. 1, is the most general case for a completely polarized beam, with the electric field vector tracing an ellipse in transverse coordinates as the light propagates. Linear and circular polarization are degenerate cases of elliptical polarization, with the electric field vector describing a line or circle with propagation, respectively, instead of an ellipse.

A polarization state may also be described using a Stokes vector S. This formalism assumes that the light's intensity is measured through a 50 percent transmitting filter (defined to be I₀), a perfect horizontal linear polarizer (defined to be I₁), a perfect linear polarizer with its transmission axis at 45 degrees from the horizontal axis (defined to be I₂), and a perfect right circular polarization filter (defined to be I₃). Then, the vector S may be expressed as:

$$S = [ \begin{matrix}{S}_{0} \\ {S}_{1} \\ {S}_{2} \\ {S}_{3}\end{matrix} ] = \begin{matrix}2 {I}_{0} \\ 2 {I}_{1} - 2 {I}_{0} \\ 2 {I}_{2} - 2 {I}_{0} \\ 2 {I}_{3} - 2 {I}_{0}\end{matrix} \qquad ( Eq . 1 )$$

The individual Stokes parameters Sᵢ have their own physical significance. S₀ is the total intensity and is typically normalized to one. The parameters S₁ through S₃ measure the degree of horizontal linear polarization versus vertical linear polarization, +45 degrees linear polarization versus −45 degrees linear polarization, and left circular polarization versus right circular polarization, respectively.

Measurements of a light's polarimetric state have several practical applications. Polarimetric imaging—the imaging of a scene according to the polarization content of the light it emits or reflects—can facilitate object and scene recognition. Measuring the polarimetric state of a beam of light travelling through a medium permits the characterization of the medium in terms of power loss, reflectance, and other characteristics. Then, measured transmission impairments in the medium can be countered by polarization scrambling and launch-polarization control. As a fiber in a dense-wavelength division multiplexing (DWDM) system may contain a large number of independent wavelength channels, each with a finite bandwidth, it is also desirable to have a multichannel polarimeter to simultaneously determine the polarization state of each DWDM wavelength channel in a spectral waveband.

Prior art solutions for measuring the polarimetric state of light typically require control over the light source, altering the light emitted by the light source in a way that facilitates the measurement of its polarimetric state. However, it is typically infeasible to alter the operation of a light source in an optical system that is currently in service (e.g., transmitting voice data) without taking the system off-line, losing data or transmission capacity. A need therefore exists for apparatus and methods capable of determining the polarization parameters of light without directly controlling the source of the light.

### SUMMARY OF THE INVENTION

The present invention provides apparatus and methods for polarimetric measurements across a spectral range. In accord with the present invention, a phase delay is introduced between orthogonal polarization components in an incident light signal. The resulting intensity changes are used to compute parameters indicative of the polarimetric state of the light, as discussed in greater detail below. These measurements may be used, by way of example, for polarimetric imaging, polarimetric component characterization, and determining the polarimetric state across one or more wavelength bands in a wavelength division multiplexed (WDM) fiber optic channel

In one aspect, the present invention provides an apparatus for polarimetric state measurement across a spectral range. In one embodiment, the apparatus comprises a phase modifier and a polarization state detector. The phase modifier receives incident light having a plurality of polarization components and provides a dithered light, and the polarization state detector receives the dithered light and determines a polarization state thereof. The phase modifier provides the dithered light by introducing a variable phase delay between two orthogonal components of the incident light. The phase modifier may receive the incident light through free space, through an optical fiber, or from a collimator. The introduced phase delay may be continuous and varying with time or a set of discrete phase steps.

In one embodiment, the phase modifier comprises an optical rotator and a variable retarder. The optical rotator rotates the semi-major axis of the incident light by an angle θ and the variable retarder introduces the variable phase delay between the two orthogonal polarization components. In one version of this embodiment, the angle θ assumes at least two different values. Suitable optical rotators include Faraday rotators and combinations of waveplates, such as free-space birefringent crystals, waveguide devices, or fiber squeezers. Suitable phase retarders include fixed-axis liquid crystal retarders, spatially-dithering mirrors, and variable retardance waveplates (such as waveguides and fiber squeezers).

In a further embodiment, the apparatus includes a beam splitter, which receives the incident light and splits the incident light into two orthogonal polarization components. The beam splitter may be a polarizing beam splitter. The apparatus further includes a beam combiner that receives the two orthogonal polarization components and provides a combined light. The beam combiner may comprise a polarization beamsplitter, two quarterwave plates and two mirrors, where the quarterwave plates each rotate its respective polarization component and the mirrors each receive its respective rotated polarization component and reflect it.

In one embodiment, the polarization state detector comprises a polarizer and an electro-optic detector. In another embodiment, the polarization state detector comprises a polarizer, one of a demultiplexer and a spectrograph for receiving the dithered light, and a plurality of electro-optic detectors. In a third embodiment, the polarization state detector comprises a polarizer, a tunable filter, and an electro-optic detector.

In another aspect, the present invention provides a method for polarimetric state measurement across a spectral range. In one embodiment, the method operates on light having a plurality of polarization components. A variable phase delay is introduced between a first orthogonal pair of polarization components, and parameters associated with the light are then measured. A variable phase delay is introduced between a second orthogonal pair of polarization components, and parameters associated with the light are then measured. The polarization state of the light is determined based on these measurements. The variable phase delay may be a discrete delay profile or a continuous periodic delay profile, such as a sinusoidal profile ranging from 0 and 2π radians.

In one embodiment, parameters associated with the light are measured by generating an interference pattern using the light after the introduction of the variable phase delay, and measuring the intensity of the interference pattern to provide a set of intensity values. First and second sets of intensity values can be decomposed into constant, cosine, and sine component values. The constant, cosine, and sine component values can be used to compute the aforementioned Stokes parameters, for example, such that S₁/S₀=−C_{θ2}, S₂/S₀=C_{θ1}/ 2, S₃/S₀=−S_{θ1}/2, and S₀²=S₁²+S₂²+S₂³.

The foregoing and other features and advantages of the present invention will be made more apparent from the description, drawings, and claims which follow.

### BRIEF DESCRIPTION OF THE DRAWINGS

The advantages of the invention may be better understood by referring to the following description taken in conjunction with the accompanying drawings in which:

FIG. 1 illustrates the variation in the electric field of an elliptically polarized light propagating through space;

FIG. 2 illustrates a first embodiment of a polarimetric measuring apparatus in accord with the present invention;

FIG. 3 depicts an embodiment of the incident light source 200 of FIG. 2;

FIGS. 4 and 5 illustrate embodiments of the phase modifier 204 of FIG. 2;

FIG. 6 shows an embodiment of the polarization state detector 208 of FIG. 2;

FIG. 7 illustrates a second embodiment of a polarimetric measuring apparatus in accord with the present invention; and

FIG. 8 is a flowchart presenting an embodiment of a method for measuring polarization state in accord with the present invention;

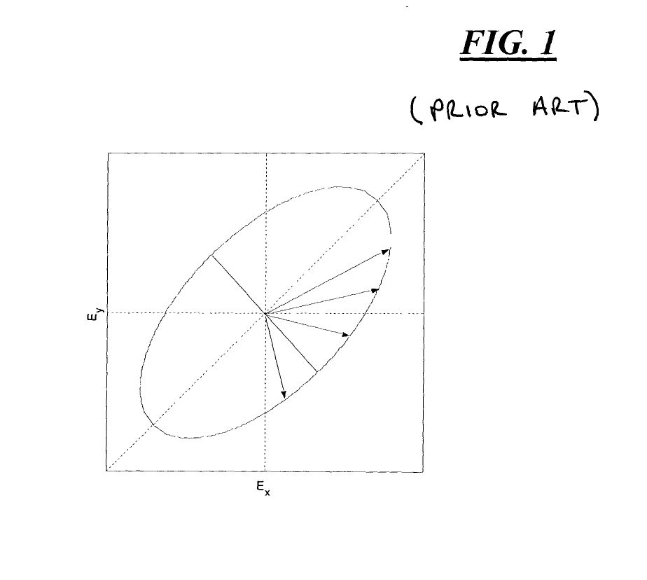

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

In brief overview, Applicants' invention provides apparatus and methods for measuring the polarimetric state (i.e., the polarization parameters) of light across a spectral waveband. A variable phase delay is introduced between orthogonal polarization components of the incident light. After introducing the delay, the orthogonal polarization components are interfered to form an interference pattern. Measurements of the resulting interference pattern are used to compute the polarization parameters of the incident light across various spectral bands.

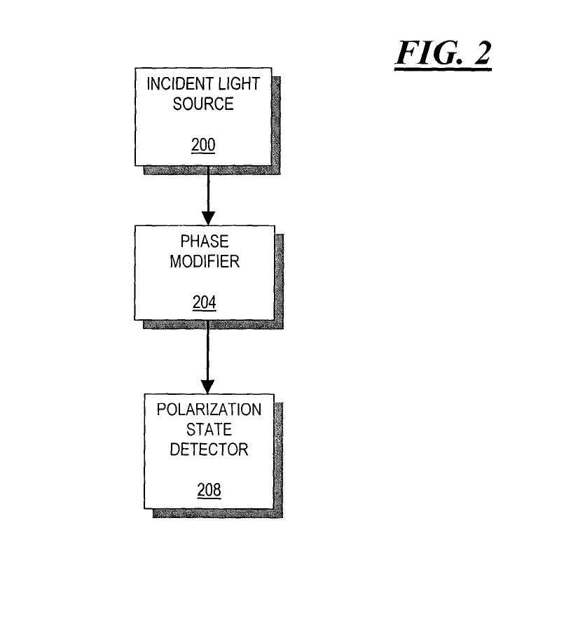

FIG. 2 illustrates a first embodiment of the present invention having a light source 200, a phase modifier 204, and a polarization state detector 208. The phase modifier 204 receives light having a plurality of polarization components from the incident light source 200. The phase modifier 204 generates a dithered light by introducing a variable phase delay between two orthogonal polarization components of the incident light. The dithered light is received and measured by the polarization state detector 208. These measurements provide sufficient data to permit the determination of the polarization state of the light source 200 in one or more spectral bands of interest. The light provided by the light source 200 may have a narrow or a wide spectral band. The spectral band of the light provided by the light source 200 may be substantially constant or it may vary with time.

The phase modifier 204 receives the light from the light source 200 and introduces a phase delay between two arbitrary orthogonal polarization components of the light. The phase delay can vary continuously with time, such as a sine wave, or can be a series of discrete phase steps. Typically the phase delay is a periodic function, for example, a series of discrete phase steps that repeats itself every 2π radians. The polarization state detector 208 receives the dithered light after the introduction of the delay and performs sufficient measurements to permit the determination of the polarization state, as discussed in greater detail below.

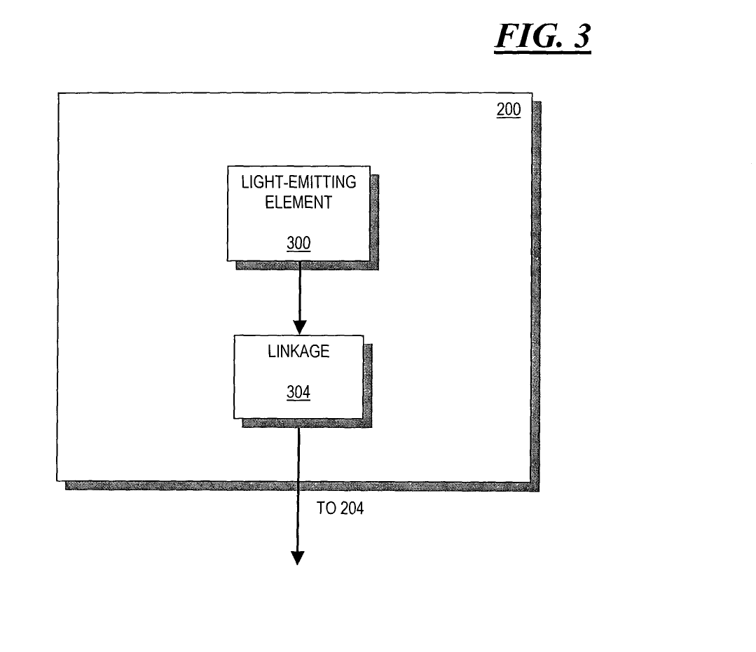

There are several suitable embodiments of the light source 200 for operation in accord with the present invention. One embodiment, illustrated in FIG. 3, consists of a light-emitting element 300 connected to a linkage 304. The light-emitting element 300 may be, for example, a laser diode, a gas laser, a solid-state laser, an arc discharge, or a similar light source.

The light-emitting element 300 serves as the source of the incident light, while the linkage 304 conveys the light between the light-emitting element 300 and the phase modifier 204. Typical linkages 304 include, but are not limited to, an optical fiber, free space, or an optical fiber in combination with a collimator.

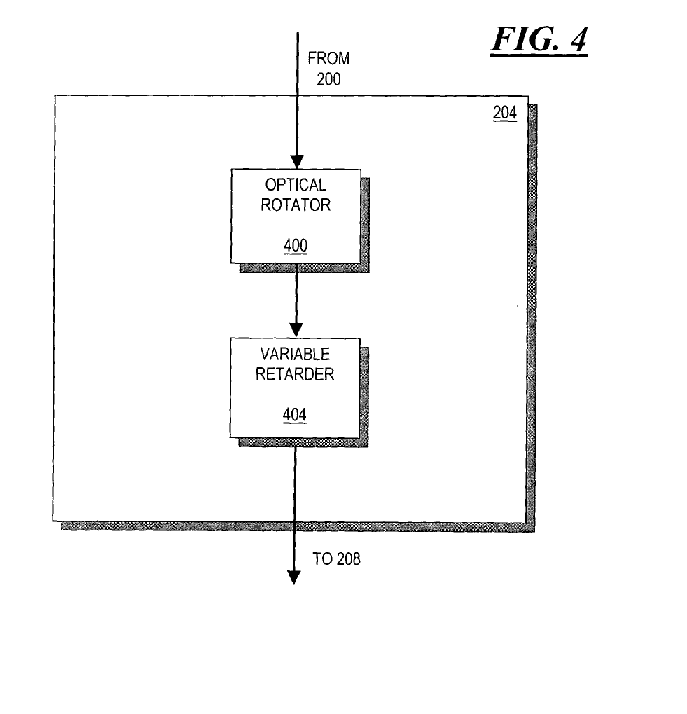

FIG. 4 illustrates a first embodiment of the phase modifier 204. In this embodiment, the phase modifier 204 includes an optical rotator 400 and a variable retarder 404 that are in optical communication. The optical rotator 400 receives the light from the light source 200 and rotates the semi-major axis of the incident light through an angle θ. The variable retarder 404 receives the rotated light and introduces a variable retardance between an arbitrary pair of orthogonal polarization components in the rotated light. The introduced retardance itself may be, for example, a value from a continuous time-varying function or a value from a set of discrete values.

The optical rotator 400 is variable in the sense that its rotator angle θ can assume at least two values, i.e., θ₁ and θ₂. Various optical equipment, either singly or in combination, may provide the functionality of optical rotator 400. For example, in one embodiment, optical rotator 400 is a Faraday rotator. In another embodiment, optical rotator 400 is two sequential switchable waveplates (free space, waveguide, or fiber squeezer, for example) with fast axes at angles of 0° and θ/2° to the y-axis. Embodiments of the variable retarder 404 include a fixed-axis liquid crystal retarder, a spatially-dithering mirror, or a variable-retardance waveplate—in particular, free space, a waveguide, or a fiber squeezer.

In some embodiments, the phase modifier 204 or the variable retarder 404 physically separate the incident light from light source 200 into its orthogonal polarization components before introducing the variable retardance, i.e., dithering the light. Embodiments that separate the light into its polarization components typically recombine the polarization components into a single beam after dithering.

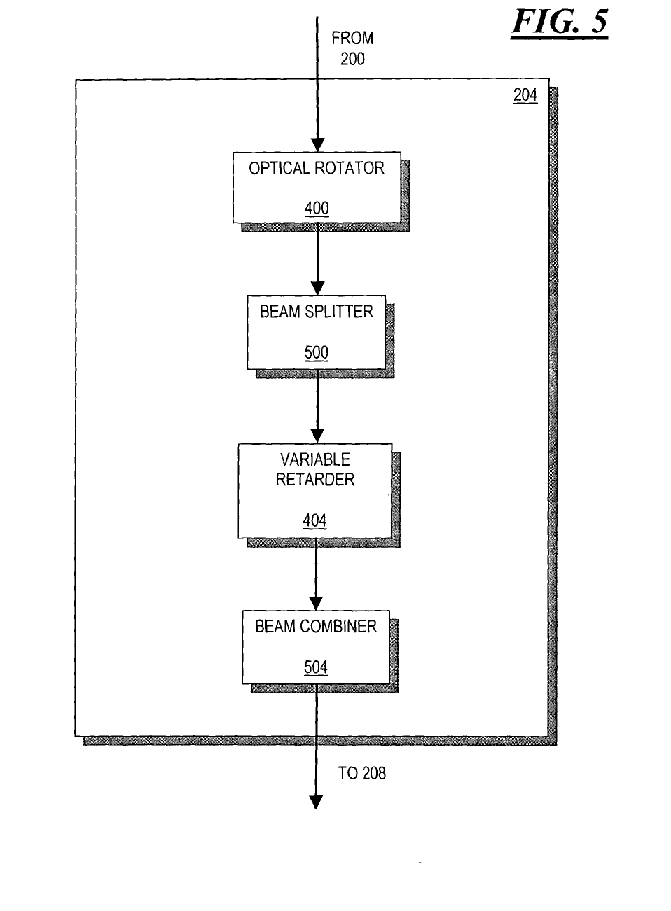

FIG. 5 illustrates a second embodiment of the phase modifier 204 that separates and recombines the orthogonal polarization components of the incident light. In this embodiment, the phase modifier 204 includes the optical rotator 400 and the variable retarder 404 discussed above, but also includes a beam splitter 500 and a beam combiner 504 in optical communication with the optical rotator 400 and the variable retarder 404. The beam splitter 500 receives the light from the optical rotator 400 and splits it into orthogonal polarization components. While the beam is separated, the variable retarder 404 introduces a variable retardance between the components. Alternately, two separate variable retarders 404¹ and 404², one for each orthogonal beam, may introduce retardances into the beams. The beam combiner 504 receives the dithered light and combines the polarization components into a single beam.

Beam splitter 500 may be, for example, a polarizing beam splitter. In one embodiment, beam combiner 504 is a polarizing beamsplitter, a pair of quarterwave plates, and a pair of reflectors, with one quarterwave plate and one reflector in the path of each polarization component to rotate the component before recombination.

In embodiments lacking beam splitter 500 and beam combiner 504, the optical rotator 400 and variable retarder 404 provide similar functionality when the fast and slow axes of the variable retarder 404 are referenced to the x- and y-axes of the rotator 400. This approach achieves a similar result because a constant phase shift of both polarization components has no effect on the resulting intensity patterns, whereas the relative phase difference, i.e., the retardance between the orthogonal polarization components, does affect the intensity measurements, as discussed further below.

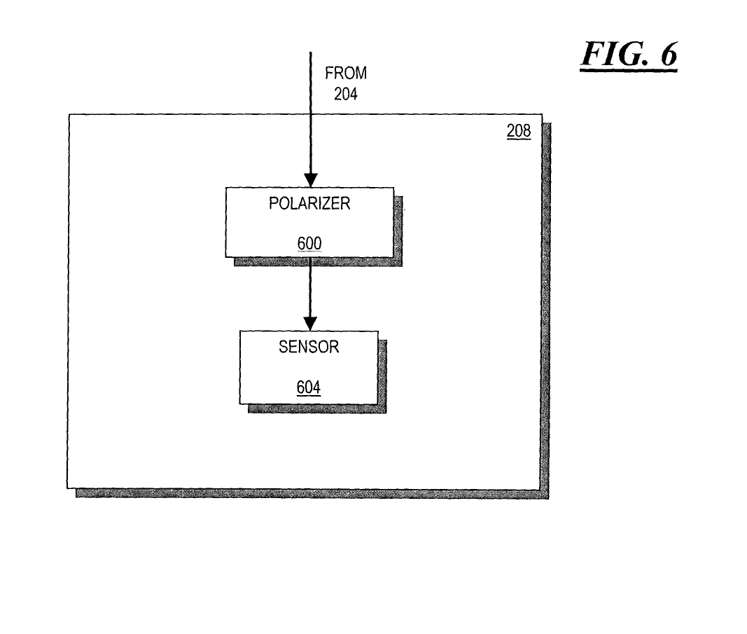

FIG. 6 illustrates an embodiment of the detector 208. This embodiment includes a polarizer 600 in optical communication with a sensor 604. The polarizer 600 is typically oriented at an angle between the orientations of the two orthogonal polarization components so that it interferes the orthogonal polarization components of the dithered beam. The result is an interference pattern that is suitable for measurement by sensor 604. In one embodiment, polarizer 600 is a 45 degree linear polarizer.

The form of sensor 604 may vary according to the desired measurement parameters. If the desired measurement parameter is the average polarization state across a waveband, then the sensor 604 may be, for example, a single electro-optic detector. If the desired measurement parameter is the polarization state among a set of bins contained in the waveband, then the sensor 604 may be, for example, a demultiplexer or spectrograph illuminating a series of detectors or a detector array. In this embodiment, the demultiplexer or spectrograph disperses the interfered beam across the detectors. The output of each detector then characterizes a narrow wavelength band within the larger waveband. For example, a 256-element array would allow for the polarimetric characterization of 256 spectral channels. In still another embodiment, the sensor 604 is a tunable filter in optical communication with a single electro-optic detector. In this embodiment, the frequency bins are sampled temporally rather than spatially. Suitable tunable filters include, but are not limited to, a scanning Fabry-Perot filter, a liquid crystal tunable filter, or a mechanically tuned linear variable filter.

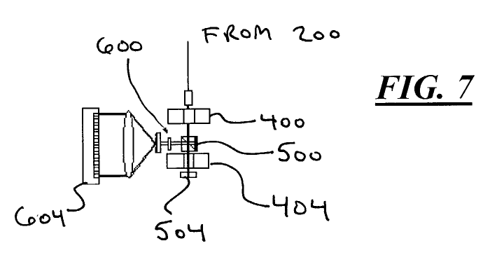

FIG. 7 illustrates a second embodiment of a polarimetric measuring apparatus in accord with the present invention. The optical rotator 400 receives the incident light from the light source 200 and rotates the semi-major axis through an angle θ. The incident light passes through the beam splitter 500 where it is split into two beams, transmitting Eₓ and reflecting E_{y}. The variable retarder 404 introduces a variable phase dither—either continuous or discrete—into one of the separated beams. A quarterwave plate and reflector in each arm form a beam combiner 504, as described above, which recombines the beams. The recombined beam passes through the polarizer 600 and produces an interference pattern. The interference pattern is dispersed across the sensor 604, which in this embodiment consists of a multiplexer in optical communication with a detector array. The resulting intensity measurements of the interference pattern may be used to determine the polarimetric state of the spectral waveband that corresponds to the particular detector element in the array. In still another embodiment, a tunable filter and a single electro-optic detector are placed after the polarizer 600 to temporally sample different frequency bins.

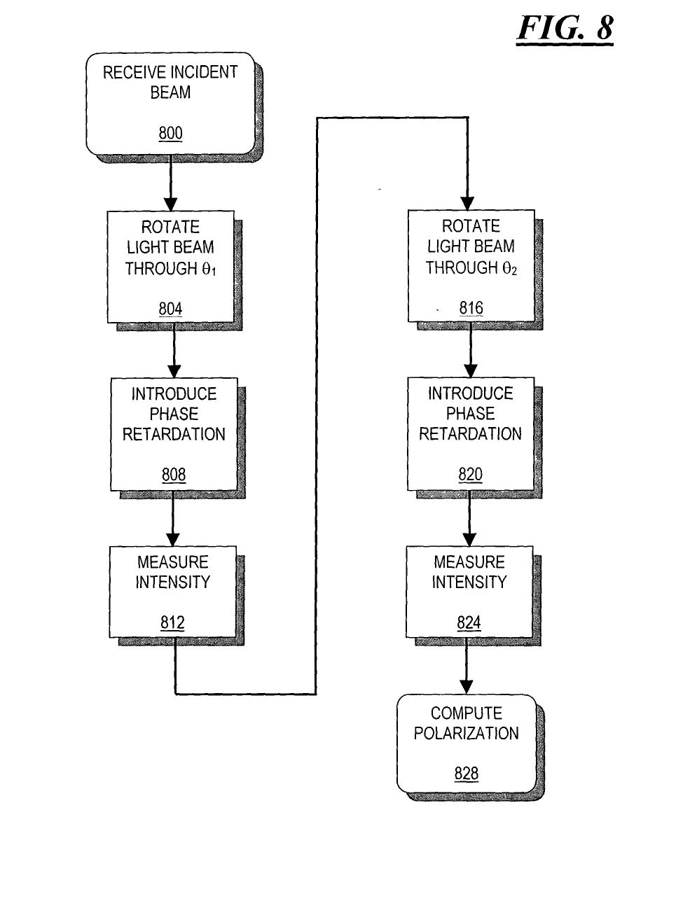

FIG. 8 illustrates measurement of polarization state in accord with the present invention. First, a polarization rotator is set to an angle θ₁, e.g., 0 degrees. The incident light signal is received (Step 800), and then rotated through θ₁ (Step 804). A variable retarder is configured to introduce a sufficient range of phase delay between the orthogonal polarization components of the rotated light (Step 808). Typical ranges of phase delay include a continuous periodic delay profile, e.g., a sinusoid from 0 to 2π radians, or a set of several discrete delay steps, e.g., between 0 and 2π radians at π/2 intervals. While the delay is introduced, sensors measure the intensity of the interference pattern formed by the polarization components of the light (Step 812). Next, the phase rotator is reconfigured to rotate the polarization state of the light by an angle θ₂ around the optical axis (Step 816). Repeating Steps 808 and 812, a variable phase delay is introduced (Step 820) and the resulting intensity pattern is measured (Step 824), as discussed above.

Certain of the discrete phase delay settings with rotator setting θ₂ may collect identical information to other phase delay settings with rotator setting θ₁ and, therefore, do not need to be repeated. For example, if θ₁=0° and θ₂=45° with a phase delay of π/2 radians yield identical signals at the detectors, only measurements from one of the two cases need to be collected.

Using these intensity measurements and knowledge of the parameters of the variable phase delay introduced between the orthogonal polarization components, the system computes the polarization parameters associated with the spectral band forming the interference pattern (Step 828). When θ₁ is 0° (for example) and the introduced phase delay is d, the expression for the measured intensity I₀ of the spectral component with frequency ω is:

$${I}_{0} = {I}^{0} \{ 1 + \frac{2 {E}_{x} {E}_{y} cos ϵ}{I} cos ( ⅆ ω ) - \frac{2 {E}_{x} {E}_{y} sin ϵ}{I} sin ( ⅆ ω ) \} \qquad ( Eq . 2 )$$

where

I⁰≡Eₓ²+E_{y}² (Eq. 3)

is the incident flux entering the polarimeter.

Similarly, when θ₂ is 45° (for example) and the introduced delay is d, the expression for the measured intensity I₄₅ of the spectral component with frequency ω is:

$${I}_{45} = {I}^{0} \{ 1 + \frac{{E}_{y}^{2} - {E}_{x}^{2}}{I} cos ( ⅆ ω ) - \frac{2 {E}_{x} {E}_{y} sin ϵ}{I} sin ( ⅆ ω ) \} \qquad ( Eq . 4 )$$

Note that, per equations (2) and (4), for each frequency ω the signal is sinusoidal with delay d:

I₀=I⁰{1+C⁰ cos(dω)+S⁰ sin(dω)} (Eq. 2′)

I₄₅=I⁰{1+C⁴⁵ cos(dω)+S⁴⁵ sin(dω)} (Eq. 4′)

where

$${C}^{0} = \{ \frac{2 {E}_{x} {E}_{y} cos ϵ}{I} \} {S}^{0} = \{ - \frac{2 {E}_{x} {E}_{y} sin ϵ}{I} \} \\ {C}^{45} = \{ \frac{{E}_{y}^{2} - {E}_{x}^{2}}{I} \} {S}^{45} = \{ - \frac{2 {E}_{x} {E}_{y} sin ϵ}{I} \} \qquad ( Eq . 5 )$$

Knowing d, and ω, the sinusoidal signals I₀(d) and I₄₅(d) can be solved for the parameters C⁰, S⁰, I⁰, C⁴⁵, and S⁴⁵. Then, in one embodiment, the Stokes parameters for each wavelength of light in the source beam are computed from these parameters. For a Stokes vector S=[S₀S₁S₂S₃]^{T}, the Stokes parameters are given by:

S₀=Eₓ²+E_{y}²

S₁=Eₓ²−E_{y}²

S₂=2EₓE_{y} cos ε

S₃=2EₓE_{y} sin ε (Eq. 6)

Comparing (Eq. 5) and (Eq. 6), the following relationship may be obtained:

$$\frac{{S}_{1}}{{S}_{0}} = - {C}^{45} \frac{{S}_{2}}{{S}_{0}} = \frac{{C}^{0}}{2} \\ \frac{{S}_{3}}{{S}_{0}} = - \frac{{S}^{0}}{2} = - \frac{{S}^{45}}{2} {S}_{0}^{2} = {S}_{1}^{2} + {S}_{2}^{2} + {S}_{3}^{2} \qquad ( Eq . 7 )$$

The method of FIG. 8 therefore yields a set of polarization parameters at each wavelength after two delay cycles. In other embodiments, polarimetric values other than Stokes parameters are determined using information obtained from measurements of the interference pattern. For example, the polarization state may be expressed in terms of a Degree of Polarization DOP, semi-major axis Θ, and an ellipticity ε, where

$$DOP = \frac{{( {S}_{1}^{2} + {S}_{2}^{2} + {S}_{3}^{2} )}^{1 / 2}}{{S}_{0}} , Θ = \frac{1}{2} arctan ( \frac{{S}_{2}}{{S}_{1}} ) , \\ ϵ = Θ = \frac{1}{2} arcsin ( \frac{{S}_{3}}{{( {S}_{1}^{2} + {S}_{2}^{2} + {S}_{3}^{2} )}^{1 / 2}} ) \qquad ( Eq . 8 )$$

Many alterations and modifications may be made without departing from the spirit and scope of the invention. Therefore, it is to be understood that these embodiments have been shown by way of example and should not be taken as limiting the invention, which is defined by the following claims. These claims are thus to be read as not only including literally what is set forth by the claims but also to include those equivalents which are insubstantially different, even though not identical in other respects to what is shown and described in the above illustrations.

What is claimed is:

1. An apparatus for polarimetric state measurement across a spectral range, comprising:
a phase modifier for receiving incident light having a plurality of polarization components and, in response thereto, providing a dithered light; and
a polarization state detector for receiving the dithered light and determining a polarization state thereof, the phase modifier providing the dithered light by introducing a variable phase delay between two orthogonal polarization components of the incident light.

2. The apparatus of claim 1 wherein the phase modifier receives the incident light through free space.

3. The apparatus of claim 1 wherein the phase modifier receives the incident light through an optical fiber.

4. The apparatus of claim 1 wherein the phase modifier receives the incident light from a fiber collimator.

5. The apparatus of claim 1 wherein the phase modifier comprises:
an optical rotator for rotating the semi-major axis of the incident light by an angle θ; and
a variable retarder for introducing the variable phase delay between the two orthogonal polarization components.

6. The apparatus of claim 5 wherein the angle θ assumes at least two different values.

7. The apparatus of claim 5 wherein the optical rotator includes a Faraday rotator.

8. The apparatus of claim 5 wherein the optical rotator includes two sequential switchable waveplates.

9. The apparatus of claim 8 wherein the waveplates are free space birefringent crystals.

10. The apparatus of claim 8 wherein the waveplates are waveguide devices.

11. The apparatus of claim 8 wherein the waveplates are fiber squeezers.

12. The apparatus of claim 8 wherein the waveplates are liquid crystal retarders.

13. The apparatus of claim 5 further comprising:
a beam splitter for receiving the incident light and splitting the incident light into two orthogonal polarization components.

14. The apparatus of claim 13 wherein the beam splitter is a polarizing beam splitter.

15. The apparatus of claim 13 further comprising:
a beam combiner for receiving the two orthogonal polarization components and providing a combined light.

16. The apparatus of claim 15 wherein the beam combiner comprises:
a first quarterwave plate for rotating the first orthogonal polarization component;
a first mirror for receiving the first orthogonal polarization component from the first quarterwave plate and reflect the component;
a second quarterwave plate for rotating the second orthogonal polarization component; and
a second mirror for receiving the second orthogonal polarization component from the second quarterwave plate and reflect the component.

17. The apparatus of claim 5 wherein the introduced phase delay is continuous and varies with time.

18. The apparatus of claim 5 wherein the introduced phase delay is a set of discrete phase steps.

19. The apparatus of claim 5 wherein the variable retarder includes a fixed-axis liquid crystal retarder.

20. The apparatus of claim 5 wherein the variable retarder includes a spatially-dithering mirror.

21. The apparatus of claim 5 wherein the variable retarder includes a variable retardance waveplate.

22. The apparatus of claim 21 wherein the variable retardance waveplate is a waveguide.

23. The apparatus of claim 21 wherein the variable retardance waveplate is a fiber squeezer.

24. The apparatus of claim 21 wherein the variable retardance waveplate has a fast axis aligned with the x-axis and a slow axis aligned with the y-axis.

25. The apparatus of claim 1 wherein said polarization state detector comprises:
a polarizer; and
an electro-optic detector.

26. The apparatus of claim 1 wherein said polarization state detector comprises:
a polarizer;
one of a demultiplexer and a spectrograph for receiving the dithered light; and
a plurality of electro-optic detectors.

27. The apparatus of claim 1 wherein said polarization state detector comprises:
a polarizer;
a tunable filter; and
an electro-optic detector.

28. A method for polarimetric state measurement across a spectral range comprising:
(a) receiving light having a plurality of polarization components;
(b) introducing a phase delay between a first orthogonal pair of the polarization components;
(c) measuring parameters associated with the light after the completion of step (b);
(d) introducing a phase delay between a second orthogonal pair of polarization components;
(e) measuring parameters associated with the light after the completion of step (d); and
(f) determining the polarization state of the light from at least some of the measured parameters.

29. The method of claim 28 wherein the phase delay of at least one of step (b) and step (d) is a continuous periodic delay.

30. The method of claim 29 wherein the continuous periodic delay profile is a sinusoidal profile ranging between 0 and 2π radians.

31. The method of claim 28 wherein the phase delay of at least one of step (b) and step (d) is a discrete delay profile.

32. The method of claim 28 wherein step (c) comprises the steps:
(c-1) generating an interference pattern using the light; and
(c-2) measuring the intensity of the interference pattern to provide a first set of intensity values.

33. The method of claim 28 wherein step (e) comprises the steps:
(e-1) generating an interference pattern using the light; and
(e-2) measuring the intensity of the interference pattern to provide a second set of intensity values.

34. The method of claim 28 wherein step (f) comprises the steps:
(f-1) receiving a first set of intensity values and a second set of intensity values;
(f-2) decomposing the first set of intensity values into a constant component I_{θ1}, a cosine component C_{θ1} and a sine component S_{θ1};
(f-3) decomposing the second set of intensity values into a constant component I_{θ2}, a cosine component C_{θ2} and a sine component S_{θ2}; and
(f-4) computing the Stokes parameters S₀, S₁, S₂, and S₃ using C_{θ1}, C_{θ2}, S_{θ1}, and S_{θ2}.

35. The method of claim 34 wherein S₁/S₀=−C_{θ2}, S₂/S₀=C₀₁/2, S₃/S₀=−S_{θ1}/2, and S₀²=S₁²+S₂²+S₂³.
